(19) United States
(12) Patent Application Publication
(10) Pub. No.: US 2022/0087266 A1
(43) Pub. Date: Mar. 24, 2022

(54) COMPOSITIONS AND METHODS FOR CONTROLLING MYCOTOXIN PRODUCTION

(71) Applicant: MARS, INCORPORATED, McLean, VA (US)

(72) Inventors: John M. CARNEY, Portland, OR (US); Guangtao ZHANG, New York, NY (US); Chigozie Victor NWOSU, Chicago, IL (US)

(21) Appl. No.: 17/478,017

(22) Filed: Sep. 17, 2021

Related U.S. Application Data
(60) Provisional application No. 63/081,394, filed on Sep. 22, 2020.

(51) Int. Cl. A01N 63/40; A01N 25/12

(52) U.S. Cl. CPC A01N 63/40; A01N 25/12

(57) ABSTRACT

Provided herein are methods of inhibiting or preventing fungal growth and/or toxin development. In particular, provided herein are methods comprising applying a composition comprising mycovirus lysin to a plant, plant part, or plant product in an amount sufficient to inhibit or reduce fungal growth. Also provided are methods of minimizing aflatoxin contamination of a peanut-based food product comprising applying a composition comprising mycovirus lysin to peanuts in an amount sufficient to inhibit or reduce A. flavus or A. parasiticus growth.

### FIELD OF THE DISCLOSURE

The disclosure generally relates to methods of inhibiting or reducing fungal growth and/or toxin production.

### BACKGROUND

Mycotoxins are naturally occurring substances produced by certain species of fungi including, for example, Aspergillus sp., Fusarium sp., Penicillium sp. These fungi commonly grow on and infest plant materials such as grains, oilseeds, and grasses. They are most often produced in the field under conditions of environmental stress on the plant (e.g., heat, insects, and drought), but can also be produced during storage of the plant or plant product. Mycotoxins include aflatoxins, ochratoxins, zearalenones, T-2 toxin, HT-2 toxin, diacetoxyscirpenol, monoacetoxyscirpenol, neosolaniol, nivalenol, deoxynivalenol, 3-acetaldeoxynivalenol, T-2 tetraol, scirpentriol, fusarenon, crotoxin, satratoxin H, and the like. To date, over 400 different mycotoxins have been identified.

Aflatoxins are mycotoxins that present remarkable toxicity and hepatocarcinogenicity. Aflatoxins can cause diverse toxic effects on virtually all organs, eventually leading to the development of cancerous tumors capable of spreading throughout the entire body. Acute exposure of aflatoxins can cause death. Consumption of aflatoxin contaminated food is associated with stunting. There are four major aflatoxins: AFB₁, AFB₂, AFG₁ and AFG₂, that contaminate crops, with AFB₁ and AFG₁ having greater toxic potential than aflatoxins AFB₂ and AFG₂. The International Agency for Research on Cancer has noted that the major forms AFB₁ and AFG₁ are potent carcinogens, linked primarily to cancer of the liver. Thus, the amount of aflatoxin allowed in human and animal food is regulated by State and Federal agencies. Other mycotoxins, such as fumonisin B₁ and trichothecenes (e.g., T-2 toxin, deoxynibvalenol or vomitoxin; ergot, zearolenone, cyclopiazonic acid, patulin, ochratoxin A, and secalonic acid D) are also known to cause toxic effects in humans, horses, and swine. In particular, fumonisin B₁ is a mycotoxin that occurs on corn and has been linked to esophageal cancer in humans and toxic effects in horses and swine. Trichothecenes can negatively affect human and animal health due to their diverse toxic effects. The toxic effects of mycotoxins can be acute or chronic, depending on the level and duration of mycotoxin exposure and species sensitivity.

Improved methods and compositions for killing fungal growth on plant and plant parts and in particular plant and plant parts which serve the basis of commercial food products, are needed.

### SUMMARY

The disclosure provides, e.g., a method comprising applying a composition comprising mycovirus lysin to a plant, plant part, or plant product in an amount sufficient to inhibit or reduce fungal growth. In various embodiments, the plant part is a seed, nut, fruit, stem, root, leaf, or flower. Optionally, the plant product is partially processed for preparation of a food product. In various embodiments, the plant part is a peanut.

In various embodiments, the fungus belongs to the genus Aspergillus, Penicillium, Fusarium, Byssoclamys, Alternaria, Trichoderma, Myrothecium, Phomopsis, Trichothecium, or Stachybottrys. In various embodiments, the fungus is A. flavus, A. parasiticus, A. terreus, A. candidus, A. carbonarius, A. niger, A. ochraceus, A. clavatus, or A. giganteus. In various embodiments, the fungus is P. citrinum, P. verrucosum, P. expansum, P. claviforme, P. urticae, or P. patulum. In various embodiments, the fungus is F. verticillioides, F. proliferatum, F. fujikuroi, F. graminearum, F. culmorum, F. sporotrichioides, F. semitectum, F. equiseti, or F. oxysporum. In various embodiments, the fungus is B. fulva or B. nivea. In various embodiments, the fungus is Alternaria alternate. In various embodiments, the fungus is A. flavus or A. parasiticus.

In various embodiments, the composition is a dry powder.

In various embodiments, the concentration of mycovirus lysin in the composition is between about 0.001 ppb and about 100,000 ppb.

In various embodiments, the mycovirus lysin is applied in an amount which reduces aflatoxin contamination in a sample of in-shell peanuts by about 50% compared to an untreated sample.

Also provided herein is a method of minimizing aflatoxin contamination of a peanut-based food product, the method comprising applying a composition comprising mycovirus lysin to peanuts in an amount sufficient to inhibit or reduce A. flavus or A. parasiticus growth.

Further aspects of the disclosure may become apparent to those skilled in the art from a review of the following detailed description, taken in conjunction with the examples and appended claims. While the invention is susceptible to embodiments in various forms, described herein are specific embodiments of the invention with the understanding that the disclosure is illustrative, and is not intended to limit the invention to specific embodiments described herein. For example, where features are described with language such as “one aspect,” “some aspects,” “various aspects,” etc. each of these types of embodiments is a non-limiting example of a feature that is intended to be combined with any other feature, or combination of features, described herein without having to list every possible combination. Such features or combinations of features apply to any of the aspects of the invention.

The headings herein are for the convenience of the reader and not intended to be limiting. Additional aspects, embodiments, and variations of the invention will be apparent from the Detailed Description and/or drawings and/or claims.

### DETAILED DESCRIPTION

The disclosure provides, e.g., methods comprising applying a composition comprising mycovirus lysin to a plant, plant part, or plant product in an amount sufficient to inhibit or reduce fungal growth. The disclosure further provides methods of minimizing aflatoxin contamination of a peanut-based food product, comprising applying a composition comprising mycovirus lysin to peanuts in an amount sufficient to inhibit or reduce A. flavus or A. parasiticus growth.

Mycoviruses are viruses that infect fungi and are generally selective to particular species of fungal hosts. Although presence of mycoviruses can be considered undesirable when they attack commercial fungal products (e.g., mushrooms), they can serve a beneficial role if used as a biological control agent of fungal contaminants in economically important plants, such as peanuts, corn, and rice. Many mycovirus lifecycles involve replication inside host fungi, but not all entail a traditional lytic cycle for phage progeny release, and some have extracellular aspects to their life cycle. No enzymology literature exists on the gene expression profile for mycoviruses as they relate to lysins. Surprisingly, the inventors have discovered that a sub-group of mycoviruses with an extracellular component to their life cycle have enzymatic systems that osmotically kill targeted host cells as part of their extracellular lifecycle. Lysin proteins have been identified in bacteriophages, which are distinct from mycovirus. Unlike bacteriophages, mycoviruses that infect, e.g., Aspergillus fungi, are RNA viruses (bacteriophage are DNA viruses). The infected fungi do not go through a traditional lytic cycle for phage progeny release; as such, these RNA viruses were not known to produce true viral lytic enzymes similar to those of bacteriophage. Additionally, the cell wall of Aspergillus does not include true peptidoglycan, unlike gram-positive bacteria which are susceptible to lysin. Rather, the cell wall structure of fungi such as Aspergillus is a combination of chitin and other carbohydrates such as, β-(1,3)-glucan, β-(1,3)-β-(1,4)-glucan, α-(1,3)-glucan, galactomannan, and galactosaminogalactan (GAG). Given the unusual nature of these fungi and distinct type of virus, it was not predictable that a phage-derived lysin could be effective to control fungal growth.

In aspects, the disclosure provides applying mycovirus lysin to a plant part, for example to the surface of a peanut or shelled peanut, to, e.g., minimize production of mycotoxins by killing Aspergillus or other fungi that germinates from the plant or may be introduced during the storage process. Since some fungi share the same or similar structural macromolecule targeted by the mycovirus lysin, use of the mycovirus lysin may achieve broad spectrum activities and benefits against several related or unrelated fungi.

The methods and compositions of the disclosure can inhibit or reduce fungal growth on a plant or a plant product. Additionally, the methods and compositions can inhibit or reduce toxin (e.g., mycotoxin) development or release by a fungus. As defined herein, “inhibiting or reducing” fungal growth or toxin development, and variants thereof, refers to any slowing, interruption, suppression, delay, or inhibition of the fungal growth and/or the toxin (e.g., mycotoxin) development. Inhibiting or reducing fungal growth can, for example, comprise inhibiting or reducing growth of resting fungal cells, which can include spore germination, mycelia development, and/or the formation of fruiting structures on the fungus (e.g., sporangia/sporophores). Fungus includes, for example, mold, yeast, mildew, fungi that cause smut, fungi that cause rust, fungi that cause diseases of plants, and fungi that cause diseases of animals.

The fungus can be any mycotoxin-producing fungus, such as, but not limited to, Aspergillus, Penicillium, Fusarium, Byssoclamys, Alternaria, Claviceps, Trichoderma, Myrothecium, Phomopsis, Trichothecium, Stachybottrys, or combinations thereof. These fungi can generally grow at temperatures ranging from about −5° C. to about 45° C. In embodiments, the fungus belongs to the genus Aspergillus. In embodiments, the fungus is A. flavus, A. parasiticus, A. terreus, A. candidus, A. carbonarius, A. niger, A. ochraceus, A. clavatus, or A. giganteus. In embodiments, the fungus belongs to the genus Penicillium. In embodiments, the fungus is P. citrinum, P. verrucosum, P. expansum, P. claviforme, P. urticae, or P. patulum. In embodiments, the fungus belongs to the genus Fusarium. In embodiments, the fungus is F. avenaceum, F. poae, F. verticillioides, F. proliferatum, F. fujikuroi, F. graminearum, F. culmorum, F. sporotrichioides, F. semitectum, F. equiseti, or F. oxysporum. In embodiments, the fungus belongs to the genus Byssoclamys. In embodiments, the fungus is B. fulva or B. nivea. In embodiments, the fungus belongs to the genus Alternaria. In embodiments, the fungus is Alternaria alternate. In embodiments, the fungus belongs to the genus Claviceps. In embodiments, the fungus belongs to the genus Trichoderma. In embodiments, the fungus belongs to the genus Myrothecium. In embodiments, the fungus belongs to the genus Phomopsis. In embodiments, the fungus belongs to the genus Trichothecium. In embodiments, the fungus belongs to the genus Stachybottrys.

As described herein, the methods and compositions of the disclosure can inhibit or reduce mycotoxin-producing fungal infections of agricultural products, such as plants, plant parts, or plant products. The plant, plant part, or plant product can be an agricultural, aquacultural, and/or maricultural plant, plant part, or plant product. Examples of plants include, but are not limited to, corn, Brassica sp., alfalfa, rice, rye, sorghum, millet, sunflower, safflower, wheat, soybean, tobacco, potato, peanuts, tree nuts (e.g., almonds, pistachio, hazelnut, cashew, brazil nuts, etc.) sweet potato, cassava, coffee, coconut, apple, pineapple, citrus trees and other fruit trees, cocoa, tea, banana, avocado, fig, guava, mango, olive, papaya, cashew, macadamia, almond, sugar beets, sugarcane, oats, barley, tomatoes, lettuce, green beans, lima beans, peas, cucumber, and ornamentals. Also provided are plant parts derived from any of the aforementioned plants. In embodiments, the plant part is a seed, nut, stem, root, flower, or leaf. Also provided are processed plant products obtained from any of the aforementioned plants or plant parts, such as a meal, paste, flour, flake, or feed generated by processing the plant or plant product. Examples of processed plant products include, but are not limited to, peanut meal or flour, peanut protein, corn gluten meal, distiller grains, wheat middlings, grain products, and the like. In embodiments, the plant, plant part, and/or plant product is a peanut. The peanut can be a shelled or unshelled peanut. In embodiments, wherein the plant (or part or product thereof) comprises a peanut, the fungus can be A. flavus or A. parasiticus.

The methods of the disclosure can be used to inhibit or reduce any mycotoxin produced by any one or more of the fungi described herein. In embodiments, the methods of the disclosure are used to inhibit or reduce aflatoxin production. Other examples of mycotoxins include, but are not limited to, citrinin, fumonisin, ochratoxin, patulin, deoxynivalenol (DON, or vomitoxin), trichothecenes, beauvercin, enniatin, butenolide, equisetin, fusarin, ergot alkaloid, and zearalenone. Many of these mycotoxins are chemically and thermally stable, which can lead to difficulties in mitigating and/or preventing contamination of food products. For example, mycotoxins are not susceptible to high temperatures, such as those used for traditional cooking, frying, roasting, toasting, and the like. The mycovirus lysin of the disclosure, or any composition comprising mycovirus lysin, can be added as a preservative in the prevention of mycotoxin contamination of food product (or ingredient) during long-term storage and extend the shelf-life of final food compositions.

The methods described herein can be effective in inhibiting or reducing the mycotoxin contamination of agricultural crops, such as any one or more of the aforementioned plants, plant parts, or plant products, by field application of the mycovirus lysin or a composition comprising the mycovirus lysin. The mycovirus lysin, or a composition thereof, can be applied to the surface of the plant, plant part, or plant product as a powder, in solution as a spray, or in solution as a field application via drip irrigation delivery system to the plant or plant part (e.g., root) in the soil. In embodiments, the composition is a dry powder. In embodiments, the composition is a liquid solution. In embodiments, the composition is a liquid solution applied via drip irrigation system or other liquid delivery systems.

The methods can be performed at any stage of growth or production of the plant or plant part. In embodiments, the mycovirus lysin, or composition thereof, can be applied during growth and development of the plant. In embodiments, the mycovirus lysin, or composition thereof, can be applied during the storage of the plants, plant parts, or plant products, for example, after the plant or plant part has been harvested. For example, in embodiments, the plant or plant part is partially processed for preparation of a food product, and the mycovirus lysin of the disclosure, or any composition containing the mycovirus lysin, remains active on the surface of the plant or plant part until it is processed and prepared into a plant product and, optionally, the final commercial (e.g., food) product. In other embodiments, the mycovirus lysin is applied to a plant product (i.e., processed plant material) to reduce or inhibit fungal growth (and, by extension, mycotoxin contamination) during storage, shipping, or further processing.

The concentration of the mycovirus lysin in the composition can be varied depending on a number of factors, such as the plant (or part or product thereof), the genera or species of the targeted fungi, and the like. In embodiments, the concentration of mycovirus lysin in the composition is between about 0.001 ppb and about 100,000 ppb, for example at least about 0.001, 0.005, 0.01, 0.05, 0.1, 0.5, 1, 10, 100, 500, 1000, 5000, or 10,000 ppb and/or up to about 100,000, 90,000, 80,000, 70,000, 50,000, 25,000, 10,000, 7500, 5000, 2500, 1000, 750, 500, 250, or 100 ppb, such as about 0.001 ppb to about 100 ppb, about 0.1 ppb to about 10,000 ppb, about 10,000 to about 100,000 ppb, or about 0.01 ppb to about 1000 ppb.

The mycovirus lysin can be applied in any amount sufficient to inhibit or reduce fungal growth. In various aspects, the mycovirus lysin is applied in an amount sufficient to minimize mycotoxin contamination to a targeted amount (e.g., to meet a local regulatory standard). It will be appreciated that “minimize” does not require a complete absence of mycotoxin but encompasses any degree of inhibition of mycotoxin production by contaminating fungi. In embodiments, the mycovirus lysin is applied in an amount which reduces mycotoxin contamination in a sample of a plant (or part or product thereof) by at least about 30% compared to an untreated sample. For example, the mycovirus lysin can be applied in an amount to reduce mycotoxin contamination in the sample by at least about 30%, 35%, 40%, 45%, 50%, 55%, 60%, 65%, 70%, 75%, 80%, 85%, 90%, or 95% compared to an untreated sample. In embodiments, the mycovirus lysin is applied in an amount which reduces aflatoxin contamination in a sample of in-shell peanuts by at least about 50% (e.g, at least about 55%, 60%, 65%, 70%, 75%, 80%, 85%, 90%, or 95%) compared to an untreated sample.

In embodiments, after application of the composition, the plant (or part or product thereof) suitably contains less than about 5000 ppb of mycotoxin (e.g., T2/HT2). For example, the application of the composition can achieve a level of mycotoxin of less than about 5000, 4000, 3000, 2000, 1000, 750, 500, 400, 300, 200, 100, 75, 50, 40, 30, 20,10, 9, 8, 7, 6, 5, 4, 3, 2, 1, 0.5, 0.1, or 0.01 ppb. In embodiments, the methods achieve an amount of mycotoxin of less than 500 ppb. In embodiments, the methods achieve an amount of mycotoxin of less than 200 ppb. In embodiments, the methods achieve an amount of mycotoxin of less than about 100 ppb, for example from about 0.01 ppb to about 100 ppb. In embodiments, the methods achieve an amount of mycotoxin of less than about 10 ppb, for example from about 0.01 ppb to about 10 ppb. In embodiments, the methods achieve an amount of mycotoxin of less than about 4 ppb, for example from about 0.01 ppb to about 4 ppb. In embodiments, the methods achieve an amount of mycotoxin of less than about 1 ppb, for example from about 0.01 ppb to about 1 ppb.

As described herein, aflatoxin (e.g., AFB₁, AFB₂, AFG₁ and AFG₂) can be produced by Aspergillus species, such as A. flavus and A. parasiticus in plants such as maize, peanuts, tree nuts (almonds, pistachio, hazelnut, cashew, brazil nuts, etc.). The methods of the disclosure, in various aspects, comprise applying mycovirus lysin in an amount sufficient to minimize the amount of aflatoxin to less than 500 ppb (e.g., reduced from about 10,000 ppb). In embodiments, the methods minimize the amount of aflatoxin to less than about 100 ppb, for example from about 0.01 ppb to about 100 ppb. In embodiments, the methods minimize the amount of aflatoxin to less than about 10 ppb, for example from about 0.01 ppb to about 10 ppb. In embodiments, the methods minimize the amount of aflatoxin to less than about 1 ppb, for example from about 0.01 ppb to about 1 ppb.

Citrinin can be produced by Penicillium and Aspergillus species, such as P. citrinum, P. verrucosum, A. terreus, and A. candidas in plants such as wheat, rice, sorghum, millet, rye, triticale, and other grains and cereals. The methods of the disclosure can minimize the amount of citrinin to less than 500 ppb (e.g., reduced from >1000 ppb). In embodiments, the methods minimize the amount of citrinin to less than about 200 ppb, for example from about 0.01 ppb to about 200 ppb. In embodiments, the methods minimize the amount of citrinin to less than about 10 ppb, for example from about 0.01 ppb to about 10 ppb. In embodiments, the methods reduce the amount of citrinin to less than about 1 ppb, for example from about 0.01 ppb to about 1 ppb.

Fumonisin can be produced by Fusarium species, such as F. verticillioides, F. proliferatum, and F. fujikuroi in plants such as maize, wheat, oat, barley, and other cereals. The methods of the disclosure can minimize the amount of fumonisin to less than 1000 ppb (e.g., reduced from about 4000 ppb). In embodiments, the methods minimize the amount of fumonisin to less than about 500 ppb, for example from about 0.01 ppb to about 500 ppb. In embodiments, the methods minimize the amount of fumonisin to less than about 100 ppb, for example from about 0.01 ppb to about 100 ppb. In embodiments, the methods minimize the amount of fumonisin to less than about 1 ppb, for example from about 0.01 ppb to about 1 ppb, such as about 0.22 ppb.

Ochratoxin can be produced by Penicillium and Aspergillus species, such as P. verrucosum, A. carbonarius, A. niger, and A. ochraceus. The methods of the disclosure can minimize the amount of ochratoxin to less than 2000 ppm (e.g., reduced from >4000 ppm). In embodiments, the methods minimize the amount of ochratoxin to less than about 1000 ppm, for example from about 0.01 ppm to about 1000 ppm. In embodiments, the methods minimize the amount of ochratoxin to less than about 100 ppm, for example from about 0.01 ppm to about 100 ppm. In embodiments, the methods minimize the amount of ochratoxin to less than about 1 ppm, for example from about 0.01 ppm to about 1 ppm.

Patulin can be produced by more than 60 species of fungi belonging to greater than 30 genera, such as P. expansum, P. claviforme, P. urticae, P. patulum, A. clavatus, A. giganteus, B. fulva, B. nivea, and Alternatria alternata, in plants such as apples, peaches, pears, grapes and other fruits that can be used to prepare juices, juice concentrates, and wines for consumption. The methods of the disclosure can minimize the amount of patulin to less than 4000 ppb (e.g., reduced from about 8000 ppb). In embodiments, the methods minimize the amount of patulin to less than about 1000 ppb, for example from about 0.01 ppb to about 1000 ppb. In embodiments, the methods minimize the amount of patulin to less than about 100 ppb, for example from about 0.01 ppb to about 100 ppb. In embodiments, the methods minimize the amount of patulin to less than about 1 ppb, for example from about 0.01 ppb to about 1 ppb.

Vomitoxin can be produced by Fusarium species, such as F. graminearum, as well as Trichoderma sp., Myrothecium sp., Phomopsis sp., Tricothecium sp., and Stachybottrys sp. in plants such as wheat, barley, sorghum, millet, and other grains, as well as rice and corn. The methods of the disclosure can minimize the amount of vomitoxin to less than 4000 ppb (e.g., reduced from about 10,000 ppb). In embodiments, the methods minimize the amount of vomitoxin to less than about 1000 ppb, for example from about 0.01 ppb to about 1000 ppb. In embodiments, the methods minimize the amount of vomitoxin to less than about 100 ppb, for example from about 0.01 ppb to about 100 ppb. In embodiments, the methods minimize the amount of vomitoxin to less than about 1 ppb, for example from about 0.01 ppb to about 1 ppb, such as 0.22 ppb.

Zearalenone can be produced by Fusarium species, such as F. graminearum, F. culmorum, F. verticilliodes (F. moniliforme), F. sporotrichioides, F. semitectum, F. equiseti, and F. oxysporum in plants such as maize, cereals, and other grains. The methods of the disclosure can minimize the amount of zearalenone to less than 5000 ppb (e.g., reduced from about 10,000 ppb). In embodiments, the methods minimize the amount of zearalenone to less than about 1000 ppb, for example from about 0.01 ppb to about 1000 ppb. In embodiments, the methods minimize the amount of zearalenone to less than about 100 ppb, for example from about 0.01 ppb to about 100 ppb. In embodiments, the methods minimize the amount of zearalenone to less than about 1 ppb, for example from about 0.01 ppb to about 1 ppb.

Any one or more of the treated plant, plant part, or plant product can be used and or processed to form a final food composition that can be safe for consumption (e.g., according to any local regulatory standard) by any human or animal. Nonlimiting examples of food compositions include juices, wines, snack food products, baby foods, pet food, animal feed, bakery products, dairy products, meal replacement products, ready meals, soups, pastas, noodles, canned foods, frozen foods, dried foods, chilled foods, oils and fats, spreads, confectionery, or mixtures thereof.

In various aspects, the food composition is a juice or a wine, for example apple juice, apple juice concentrate, or any wine, juice, or juice concentrate derived from fruits such as peaches, pears, grapes, and the like.

In various aspects, the food composition is a snack food product. As used herein, the term “snack food product” refers to a sweet or savory food product, such as fruit snacks, chips/crisps, extruded snacks, tortilla/corn chips, popcorn, pretzels, nuts, granola/muesli bars, breakfast bars, energy bars, fruit bars, and other snack bars. A snack food product may contain combinations of any of the foregoing, e.g., a pretzel and nut mix. Optionally, the food composition is a fruit snack, chips/crisps, pretzels, nuts, granola/muesli bar, breakfast bar, energy bar, fruit bar, or other snack bar. In various aspects, the food composition is a chocolate-coated food product.

In various aspects, the food composition is a baby food. Examples of baby food include, but are not limited to, prepared baby food, dried baby food, milk formula, standard milk formula, follow-on milk formula, toddler milk formula, and hypoallergenic milk formula.

In various aspects, the food composition is a bakery product, such as a muffin, bagel, cookie, brownie, pastry, and the like.

In various aspects, the food composition is a frozen food. Frozen foods refer to chilled or frozen food products, which include, but are not limited to ice cream, impulse ice cream, single portion dairy ice cream, single portion water ice cream, multi-pack dairy ice cream, multi-pack water ice cream, take-home ice cream, take-home dairy ice cream, ice cream desserts, bulk ice cream, take-home water ice cream, frozen yoghurt, artisanal ice cream, frozen ready meals, frozen pizza, chilled pizza, frozen soup, frozen pasta, frozen processed red meat, frozen processed poultry, frozen processed fish/seafood, frozen vegetables, frozen processed vegetables, frozen meat substitutes, frozen potatoes, frozen bakery products and frozen desserts.

In various aspects, the food composition is a pet food or animal feed. As used herein, the terms “pet” and “animal” are used interchangeably to refer to domestic animals including, but not limited to, domestic dogs, domestic cats, horses, cows, ferrets, rabbits, pigs, rats, mice, gerbils, hamsters, goats, and the like. Domestic dogs and cats are particular non-limiting examples of pets. The term “pet” or “animal” as used in accordance with the present disclosure can further refer to wild animals, including, but not limited to bison, elk, deer, venison, duck, fowl, fish, and the like.

As used herein, the term “pet food” or “pet food composition” means a composition intended for ingestion by a pet. Pet foods may include, without limitation, nutritionally balanced compositions suitable for daily feed, such as dry pet food (e.g., kibbles), semi-moist pet food, or wet pet food, as well as supplements and/or treats, which may or may not be nutritionally balanced. As used herein, the term “nutritionally balanced” means that the composition, such as pet food, has known required nutrients to sustain life in proper amounts and proportion based on recommendations of recognized authorities, including governmental agencies, such as, but not limited to, Unites States Food and Drug Administration's Center for Veterinarian Medicine, the American Feed Control Officials Incorporated, in the field of pet nutrition, except for the additional need for water. In various aspects, the pet food is a supplement and/or treat and the supplement and/or treat is a chew or a multi-component food.

The food composition is or can include a confectionery. For example, the food composition is, in various aspects of the disclosure, a confectionery selected from the group consisting of chocolate, frozen confections, compressed mints, cotton candy, pudding, fudge, fondant, liquorice, toffee, chewing gum, gelled candy, tableted candy, hard candy, and chewy candy. In various aspects, the food composition is a fat-based confectionery, such as chocolate, pudding, fudge, and the like. As used herein, the term “chocolate” refers to a solid or semi-plastic food and is intended to refer to all chocolate or chocolate-like compositions containing a fat-based component phase or fat-like composition, e.g., fudge, pudding. The term is intended to include standardized or non-standardized compositions conforming to the U.S. Standards Of Identity (SOI), CODEX Alimentarius and/or other international standards and compositions not conforming to the U.S. Standards Of Identity or other international standards. The term includes dark chocolate, baking chocolate, sweet chocolate, bittersweet or semisweet chocolate, milk chocolate, buttermilk chocolate, skim milk chocolate, mixed dairy product chocolate, white chocolate, sweet cocoa and vegetable fat coating, sweet chocolate and vegetable fat coating, milk chocolate and vegetable fat coating, vegetable fat based coating, pastels including white chocolate or coating made with cocoa butter or vegetable fat or a combination of these, nutritionally modified chocolate-like compositions (chocolates or coatings made with reduced calorie ingredients) and low fat chocolates, aerated chocolates, compound coatings, non-standardized chocolates and chocolate-like compositions, unless specifically identified otherwise. In various aspects, the food composition comprises at least one of cocoa solids, cocoa butter, sugar, artificial sweetener, milk powder, milk solids, and caramel.

In the United States, chocolate is subject to a standard of identity established by the U.S. Food and Drug Administration (FDA) under the Federal Food, Drug and Cosmetic Act. Definitions and standards for the various types of chocolate are well established in the U.S. Nonstandardized chocolates are those chocolates which have compositions that fall outside the specified ranges of the standardized chocolates. For example, nonstandardized chocolates result when, for example, the nutritive carbohydrate sweetener is replaced partially or completely; or when the cocoa butter, cocoa butter alternative, cocoa butter equivalent, cocoa butter extender, cocoa butter replacer, cocoa butter substitute or milk fat are replaced partially or completely; or when components that have flavors that imitate milk, butter or chocolate are added or other additions or deletions in formula are made outside the FDA standards of identify of chocolate or combinations thereof. Chocolate-like compositions are those fat-based compositions that can be used as substitutes for chocolate in applications such as panning, molding, or enrobing. An example of a chocolate-like composition is carob.

In various aspects, the food composition is a non-fat-based confectionery. Non-fat-based confectioneries include, for example, candies other than chocolate, such as compressed mints, cotton candy, frozen confections, liquorice, chewing gum, gelled candy, tableted candy, hard candy, and chewy candy.

Gelled candy (i.e., gelled confections) are sometimes called gummies, jellies, or gum drops. Gelled confections can be transparent, translucent, or opaque. Gelled confections are often chewed as they have a firm, elastic texture that appeals to consumers. As gelled confections are chewed, they break apart into smaller pieces, which then dissolve in the mouth. These smaller confection pieces dissolve slowly in the mouth and deliver flavor and sweetness as they dissolve into a pleasant syrup during chewing. Gelled confections may contain, for example, gelling agents, bulking sweetener agent, doctoring agent, flavors, actives, colors, sensates, and/or high intensity sweeteners.

Hard candy is sometimes called boiled, glass, amorphous, or rock candy. Typical forms of hard candy are lollipops and lozenges. Hard candy can be transparent, translucent, or opaque. These confectionary products dissolve slowly in the mouth and deliver flavor and sweetness as they dissolve. They also crunch when chewed; that is, they give an audible sound as they break into smaller pieces when chewed. By “hard”, it is meant that the candy is firm, non-flexible, and non-deforming at room temperature (e.g., 25° C.). The hard mass can contain some crystalline material, though crystalline material reduces candy clarity and the preferred hard candy is translucent or transparent. To be commercially acceptable, the hard candy needs to have a non-sticky surface and stable shape, both upon cooling to room temperature and after a reasonable storage at a reasonable relative humidity; that is, the hard candy must be at least as stable as sucrose: corn syrup hard candy at an 80:20 dry solids wt. % ratio.

Tableted candy is enjoyed by consumers, as they can be dissolved slowly in the mouth or crunched giving an audible sound. Tableted candies usually have a strong flavor that releases slowly and are typically used to freshen breath. Tableted candy is a food product that is generally formed by blending powders comprising bulking agents, sweetening agents, binding agents and excipients and flavors. These ingredients are generally blended together as powders and fed into a typical tableting machine to make the finished piece.

The food composition can be prepared without the addition of refined sugar or artificial sweetener. However, in some aspects the food composition further comprises one or more optional additives that are selected from an enzyme, an acidulant, a nutritional supplement, a sweetener, a divalent metal ion, an antioxidant, a coloring, a flavoring and/or combinations thereof.

The final product is a food composition suitable for packaging in single or multiple serving sizes.

In various aspects wherein the food composition is intended for human consumption, all ingredients, additives and other additions to any composition or used in any method are generally regarded as safe (GRAS) as designated by the United States FDA or FEMA GRAS as designated by the International Flavor and Manufacturing Association.

In various aspects, the food composition can be 100% organic as defined by the US Department of Agriculture, the European Commission or appropriate certifying organization. The products are preferably substantially or completely free of artificial food additives. In various aspects, the food composition is 100% all-natural ingredients.

1. A method comprising applying a composition comprising mycovirus lysin to a plant, plant part, or plant product in an amount sufficient to inhibit or reduce fungal growth.

2. The method of claim 1, wherein the fungus belongs to the genus Aspergillus, Penicillium, Fusarium, Byssoclamys, Alternaria, Trichoderma, Myrothecium, Phomopsis, Trichothecium, or Stachybottrys.

3. The method of claim 2, wherein the fungus is A. flavus, A. parasiticus, A. terreus, A. candidus, A. carbonarius, A. niger, A. ochraceus, A. clavatus, or A. giganteus.

4. The method of claim 2, wherein the fungus is P. citrinum, P. verrucosum, P. expansum, P. claviforme, P. urticae, or P. patulum.

5. The method of claim 2, wherein the fungus is F. verticillioides, F. proliferaturn, F. fujikuroi, F. graminearum, F. culmorum, F. sporotrichioides, F. semitectum, F. equiseti, or F. oxysporum.

6. The method of claim 2, wherein the fungus is B. fulva or B. nivea.

7. The method of claim 2, wherein the fungus is Alternaria alternate.

8. The method of claim 1, wherein the composition is a dry powder.

9. The method of claim 1, wherein the concentration of mycovirus lysin in the composition is between about 0.001 ppb and about 100,000 ppb.

10. The method of claim 1, wherein the plant part is a seed, nut, fruit, stem, root, leaf, or flower.

11. The method of claim 1, wherein the plant product is partially processed for preparation of a food product.

12. The method of claim 1, wherein the plant part is a peanut.

13. The method of claim 12, wherein the fungus is A. flavus or A. parasiticus.

14. The method of claim 13, wherein mycovirus lysin is applied in an amount which reduces aflatoxin contamination in a sample of in-shell peanuts by about 50% compared to an untreated sample.

15. A method of minimizing aflatoxin contamination of a peanut-based food product, the method comprising applying a composition comprising mycovirus lysin to peanuts in an amount sufficient to inhibit or reduce A. flavus or A. parasiticus growth.
